(19) United States
(12) Patent Application Publication
(10) Pub. No.: US 2020/0409507 A1
(43) Pub. Date: Dec. 31, 2020

(54) Non-Contact Input Device

(71) Applicant: Koito Electric Industries, Ltd., Shizuoka (JP)

(72) Inventor: Hidetoshi Nakai, Shizuoka (JP)

(21) Appl. No.: 16/976,180

(22) PCT Filed: Feb. 27, 2019
(86) PCT No.: PCT/JP2019/007495

§ 371 Date: Aug. 27, 2020

(30) Foreign Application Priority Data
Feb. 28, 2018 (JP) 2018-034085

(51) Int. Cl. G06F 3/042; H04N 9/31; G01S 17/08; G02B 30/56; G02B 27/14

(52) U.S. Cl. CPC G06F 3/0425; H04N 9/3141; G06F 2203/04108; G02B 30/56; G02B 27/144; G01S 17/08

(57) ABSTRACT

A non-contact input device for detecting an operation with respect to an image projected in mid-air that can increase diversity of detectable non-contact operations, is provided. The non-contact input device includes a display part configured to display an image, a mid-air projector configured to project a real image of the image in mid-air, and a distance sensor having a measuring range that covers a region in which the real image is formed, the distance sensor being configured to measure a distance to an object present within the measuring range.

### TECHNICAL FIELD

The present invention relates to a non-contact input device that detects an operation with respect to an image projected in mid-air.

### BACKGROUND ART

Patent Document 1 describes a non-contact input device that uses a mid-air projector to form, in mid-air, an image on a display as a projected image, and detects an operation by a finger or the like with respect to the projected image. As shown in FIG. 3, a non-contact input device 300 described in Patent Document 1 is provided with a sheet-like optical sensor 311 arranged on a surface of a display 310 and configured to detect infrared rays, and is further provided with an infrared illuminating unit 340 that illuminates an image formation range 330 of a mid-air projector 320. When an image of a keyboard or the like is displayed on the display 310, a real image of the keyboard or the like is formed in the image formation range 330 by the mid-air projector 320.

Reflected infrared rays from a finger or the like operating within the image formation range 330 form an image on the display 310 via the spatial projecting device 320. It is alleged that, by detecting this position with the optical sensor 311, it is able to recognize which position on the keyboard or the like has been operated.

### PRIOR ART DOCUMENT

### Patent Document

Patent Document 1: JP 5957611 B

### SUMMARY OF THE INVENTION

### Technical Problem

Since the non-contact input device 300 described in Patent Document 1 detects the reflected light that forms an image on the display 310, a detectable operation is limited to a touch operation on the image formation range 330 surface. Thus, diversity of non-contact operations is insufficient, and hence increased diversity of detectable non-contact operations is desired.

In view of this, an object of the present invention is to provide a non-contact input device for detecting an operation with respect to an image projected in mid-air that provides increased diversity of detectable non-contact operations.

### Solution to Problem

In order to solve the problem mentioned above, a non-contact input device according to one aspect of the present invention includes a display part configured to display an image, a mid-air projector configured to project a real image of the image in mid-air, and a distance sensor having a measuring range that covers a region in which the real image is formed, the distance sensor being configured to measure a distance to an object present within the measuring range. The non-contact input device may further include an operation responsive part configured to perform a responsive operation according to a measurement result of the distance sensor. The operation responsive part may control turning on and off of illumination. Further, the non-contact input device may further include a mirror, wherein the display part, the mid-air projector and the distance sensor may be arranged on a back face side of the mirror, and the real image may be formed on a front face side of the mirror. It is preferable that the mirror is arranged to include a half mirror at a region thereof located between the mid-air projector and the real image and between the distance sensor and the real image.

### Advantageous Effect of the Invention

According to the present invention, a non-contact input device for detecting an operation with respect to an image projected in mid-air that provides increased diversity of detectable non-contact operations can be provided.

### BRIEF DESCRIPTION OF THE DRAWINGS

FIG. 1 is a diagram showing a configuration of a non-contact input device according to this embodiment;

FIG. 2 is a diagram showing a modified example of the non-contact input device of this embodiment; and

FIG. 3 is a diagram showing a configuration of a conventional non-contact input device.

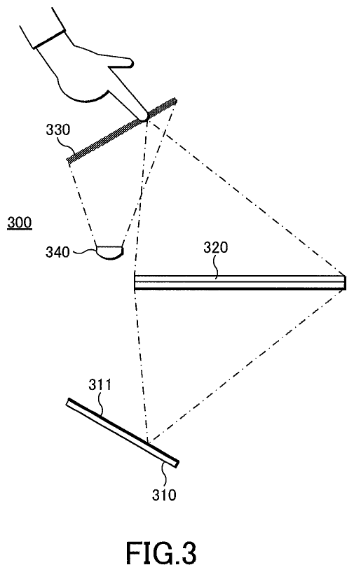

### DESCRIPTION OF EMBODIMENTS

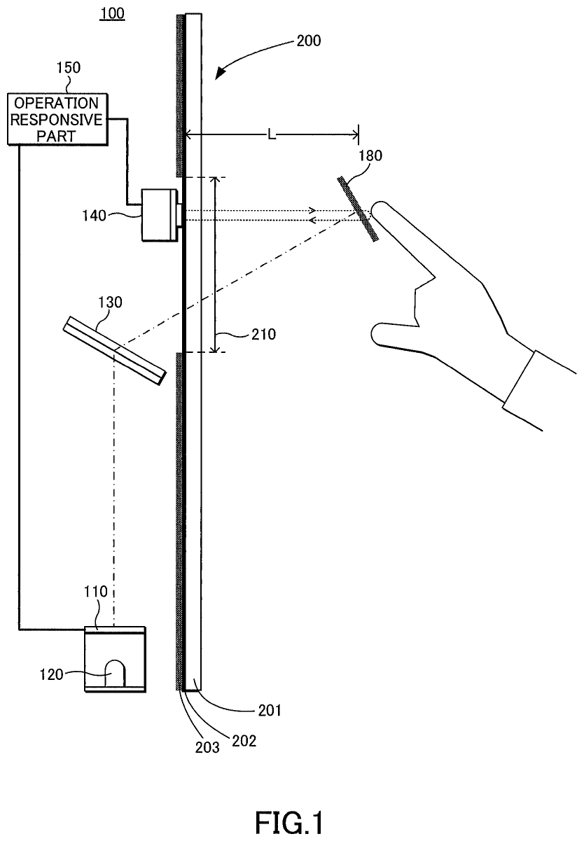

FIG. 1 is a diagram showing a configuration of a non-contact input device 100 according to this embodiment. As shown, the non-contact input device 100 includes a display part 110, a light emitting part 120, a mid-air projector 130, a distance sensor 140 and an operation responsive part 150.

The display part 110 displays an image that is to be formed as a projected image. The display part 110 may be the one that performs static display, such as a slide, or may be the one that performs dynamic display, such as a liquid crystal display device. The light emitting part 120 is a light source for projecting an image on the display part 110 and may be constituted of an LED(s) or the like. The light emitting part 120 may be omitted if the display part 110 is irradiated with sufficient external light, or if the display part 110 itself emits light, for example.

The mid-air projector 130 is a device that forms, as a projected image in mid-air, an image that has entered the mid-air projector 130. The mid-air projector may be, for example, a device that includes a plurality of first and second minute reflecting surfaces intersecting in plan view and arranged upright in the same plane, in which first reflected light from each first minute reflecting surface is received by the corresponding second minute reflecting surface to provide second reflected light. Further, the mid-air projector may be a device that uses a micro lens array or the like.

Light beams emitted from an image displayed on the display part 110 form an image via the spatial projecting device 130 on the other side of the spatial projecting device 130 at the same location and at the same distance, to form a real image 180. Thus, once a location and inclination of the display part 110 and the spatial projecting device 130 are determined, an image formation location of the real image 180 is uniquely determined.

A measuring range of the distance sensor 140 is set so as to cover a region in which the real image 180 is formed, and the distance sensor 140 measures a distance to an object present within the measuring range. In this embodiment, the distance sensor 140 is set such that the measuring range extends in a horizontal direction. However, it may be set such that the measuring range extends in an inclined direction. The distance sensor 140 may be any measurement type, for example it may be an infrared type.

The operation responsive part 150 performs a responsive operation according to a measurement result of the distance sensor 140. The operation responsive part 150 may be an illuminating device, for example. In this case, it can switch on and off of the illumination according to a measurement result of the distance sensor 140. The operation responsive part 150 may be configured to change display contents of the display part 110 according to a measurement result of the distance sensor 140.

Since a distance L between the distance sensor 140 and the real image 180 is known and the measuring range covers the region in which the real image 180 is formed, when a distance to an object measured is close to the distance L, it can be detected as an operation with respect to the real image 180. In this case, a detection target is not limited to a touch operation on a surface of the real image 180, thus diversity of detectable non-contact operations can be increased without the use of a complex configuration.

For example, by displaying an image of a switching button on the display part 110, the switching button is projected in mid-air as the real image 180. At this time, by detecting a pushing operation and such by an operator with respect to the real image 180, the operation responsive part 150 can perform a responsive operation that switches on and off of the switching button.

Further, the use of the distance sensor 140 allows to detect an operation in a depth direction with respect to the real image 180, thus the degree of pushing of the switching button can be recognized in several stages. Thus, the operation responsive part 150 may be configured to perform different responsive controls for the case where the switching button is deeply pressed and for the case where the switching button is pressed shallowly. For example, the switching button may be an illumination switching button, and bright illumination can be provided when the illumination switching button is pressed deeply while less bright illumination can be provided when the illumination switching button is pressed shallowly. Consequently, diversity of detectable non-contact operations can be further increased.

Alternatively, another possible responsive operation may include a responsive operation that makes the illumination brighter as a hand is moved closer to the real image 180 and makes the illumination dimmer as a hand is moved away from the real image 180.

Alternatively, the measuring range of the distance sensor 140 may be extended to a far distance to detect that an operator is approaching from a far away, and it may be configured such that the real image 180 is displayed on the display part 110 when the operator has approached to a predetermined distance to detect an operation with respect to the real image 180.

Further, it may be configured such that, after an operation with respect to the real image 180 of an image has been accepted, another image may be displayed on the display part 110 to accept next operation, or an image displayed may be changed to indicate that the operation has been accepted. For example, after the real image 180 of an image indicative of a turned-off state has accepted the operation, it may be switched to the real image 180 of an image indicative of a turned-on state.

As shown in FIG. 1, the non-contact input device 100 of this embodiment is positioned on the back face side of a mirror 200. The mirror 200 includes a transparent plate 201 made of glass and such, a reflection film 202 formed on one face of the transparent plate 201, and an opaque protection film 203 formed on the reflection film 202. Herein, a front surface of the mirror 200 is on the transparent plate 201 side, i.e., a side on which one can see a mirror image. It is configured such that the real image 180 is formed on the front face side of the mirror 200.

A partial region of the mirror 200 is a half mirror 210 without the opaque protection film 203 to allow the light from the mid-air projector 130, an emitted signal from the distance sensor 140 and a reflected signal from an object to transmit therethrough. A region where the half mirror 210 is preferably has a minimum size necessary to allow the light from the mid-air projector 130, the emitted signal from the distance sensor 140 and the reflected signal from an object to transmit therethrough. A transparent protection film may be formed at a region without the opaque protection film 203.

In addition, in order to prevent measurement accuracy of the distance sensor 140 from being decreased due to the reflection film 202, it is preferable to arrange the distance sensor 140 in close contact with the reflection film 202 while separating a light emission aperture and a light receiving aperture of the distance sensor 140 with a dividing member or the like.

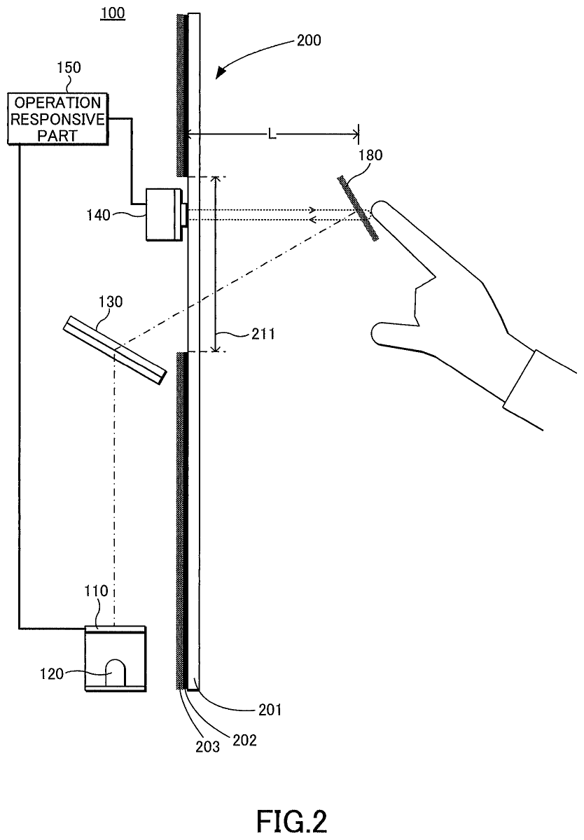

Alternatively, as shown in FIG. 2, a partial region of the mirror 200 may be a transparent surface region 211 without the reflection film 202 and the opaque protection film 203 to allow the light from the mid-air projector 130, the emitted signal from the distance sensor 140 and the reflected signal from an object to transmit therethrough. This can further increase the transmission of the emitted signal from the distance sensor 140 and the reflected signal from an object.

By placing the non-contact input device 100 on the back face side of the mirror 200 as described above, one who looks at the mirror 200 can see the real image 180 as it is popping out from the mirror 200 without recognizing the non-contact input device 100, thereby presentation effect and designability.

### REFERENCE SIGNS LIST

100 non-contact input device
110 display part
120 light emitting part
130 mid-air projector
140 distance sensor
150 operation responsive part
180 real image
200 mirror
201 transparent plate
202 reflection film
203 opaque protection film
210 half mirror

1. A non-contact input device comprising:
a display part configured to display an image;
a mid-air projector configured to project a real image of the image in mid-air; and
a distance sensor having a measuring range that covers a region in which the real image is formed, the distance sensor being configured to measure a distance to an object present within the measuring range.

2. The non-contact input device according to claim 1, further comprising an operation responsive part configured to perform a responsive operation according to a measurement result of the distance sensor.

3. The non-contact input device according to claim 2, wherein the operation responsive part is configured to perform a responsive operation that switches on and off of illumination.

4. The non-contact input device according to claim 1, further comprising a mirror, wherein
the display part, the mid-air projector and the distance sensor are arranged on a back face side of the mirror, and
the real image is formed on a front face side of the mirror.

5. The non-contact input device according to claim 4, wherein
the mirror includes a half mirror at a region thereof located between the mid-air projector and the real image and between the distance sensor and the real image.

6. The non-contact input device according to claim 2, further comprising a mirror, wherein
the display part, the mid-air projector and the distance sensor are arranged on a back face side of the mirror, and
the real image is formed on a front face side of the mirror.

7. The non-contact input device according to claim 3, further comprising a mirror, wherein
the display part, the mid-air projector and the distance sensor are arranged on a back face side of the mirror, and
the real image is formed on a front face side of the mirror.

8. The non-contact input device according to claim 6, wherein
the mirror includes a half mirror at a region thereof located between the mid-air projector and the real image and between the distance sensor and the real image.

9. The non-contact input device according to claim 7, wherein
the mirror includes a half mirror at a region thereof located between the mid-air projector and the real image and between the distance sensor and the real image.
